(19) United States
(12) Patent Application Publication
(10) Pub. No.: US 2009/0145558 A1
(43) Pub. Date: Jun. 11, 2009

(54) AUTOMATED LABEL APPLICATOR FOR LINERLESS LABELS

(75) Inventor: Rodolfo SALUZ, Buchs (CH)

Correspondence Address: BROWDY AND NEIMARK, P.L.L.C.;624 NINTH STREET, NW, SUITE 300, WASHINGTON, DC, 20001-5303, US

(73) Assignee: PAGO AG, ST.GALLEN (CH)

(21) Appl. No.: 12/330,429

(22) Filed: Dec. 8, 2008

(30) Foreign Application Priority Data
Dec. 6, 2007 (DE) 10 2007 058 765.3

(51) Int. Cl. B29C 65/50

(52) U.S. Cl. 156/530

(57) ABSTRACT

The invention relates to an automated label applicator for linerless labels (18-20) that are cut from a linerless adhesive strip (1) by means of a cutting device having a cutting knife (7), wherein the automated label applicator incorporates a roller pair (4) defining between them a roller gap (5) through which the adhesive strip (1) is transported, and wherein downstream of this roller pair (4) the cutting knife (7) is disposed, characterized in that a second roller pair (14) with a roller gap (13) is disposed downstream in such a way that the cutting knife (7) is situated in the space between the two roller pairs (4, 14), and that a tension onto the adhesive strip (1) being cut is generated in the region of the cutting knife (7) between the two roller pairs (4, 14). The technical teaching of the claimed subject matter provides the advantage that a linearly movable cutting knife can be used, permitting the cutting to take place with the adhesive strip at standstill. This results in a particularly precise cut that reliably takes place at the desired location of the adhesive strip, without large tolerance spacing (FIG. 1)

Additionally, the second roller pair effects a precise transfer of the cut label onto the transfer device as a prerequisite for accurately positioned label applications.

The invention has as its object an automated label applicator for linerless labels according to the preamble of claim 1.

With the subject matter of DE 696 17 386 T2 a semi-automatic dispenser for linerless labels has become known, in which the preprinted adhesive strip is conveyed through the roller gap of a first pair of rollers, and a cutting means is disposed downstream of this conveying direction. In order to prevent a cut label from inadvertently falling downward, out of the device, which is open at the bottom, this device provides a support for the cut label. It is true that from the text of this printed publication on page 9 the information emerges that it is preferred for supporting the labels during the cutting process and afterwards that pretensioning means are provided for pretensioning the adhesive surface of a label in contact with a holding means.

However, the subject matter here is not pretensioning means for generating a tension in the longitudinal direction of the adhesive strip, but merely that a support means is provided to prevent a cut label from inadvertently and undesirably falling out downward.

With the subject matter of WO 2005/023654 A1 an additional automated label applicator for linerless labels has become known in which, however, no tension is applied to the label web prior to the engagement of the knife. This entails the drawback that the knife strikes an untautened label web and it must be feared that tolerance spacings will result with respect to the cut label lengths. This printed publication therefore uses a rotating knife, which entails the drawback, however, that the engagement of the knife, which rotates in the direction of conveyance, does not precisely coincide with the separation cut and it must therefore be feared that tolerances in the region of the separation cut may result. The rotating knife accordingly effects both a tension to a minor degree and simultaneously also a separation cut, which is disadvantageous.

The above equipment, therefore, does not cut at standstill but during the advancement of the label sheet.

The same drawback, incidentally, also holds true for the subject matter of DE 103 51 877 A1, which does have a stationary knife but in which the cutting process is generated by a cam disc that falls against the stationary knife and, in the process, carries along the adhesive strip being cut.

Proceeding from DE 696 17 386 T2, the invention therefore has as its object to keep an adhesive strip that is to be cut, under tension in the region of the cutting device.

To meet this object, the invention is characterized by the technical teaching of claim 1.

It is an essential characteristic of the invention that a pair of rollers is disposed upstream and downstream, so that the cutting knife is disposed in the space between a first and a second roller pair, and that tension onto the adhesive strip being cut is generated in the region of the cutting device between the first and the second roller gap of the first and second roller pair.

The technical teaching of the claimed subject matter provides the essential advantage that rotating cutting knives can now be dispensed with for the first time and a linearly movable cutting knife can be used instead, which has the advantage that cutting can take place with the adhesive strip at standstill. This produces a particularly accurate precise cut that reliably takes place at the desired location of the adhesive strip without large tolerance spacing.

This results in a high degree of cutting accuracy and precise transfer of the cut label onto a downstream transfer means.

Accordingly, it is now possible for the first time to move particularly precisely cut labels onto a transfer device.

According to an additional characteristic of the invention, provision is made that the take-over speed of the transfer device is minimally greater than or identical to the discharge speed of the second roller gap disposed at the discharge side of the cutting device.

This ensures that the transfer device receives the cut labels exiting from the second roller gap without the risk of buckling and wrinkling and that in this case the labels are at the same time also applied spaced apart, so that a certain predefined spacing of the individual labels at the transfer device is ensured.

It is important in this context that the cutting device is disposed between the first and second roller pair and that cutting is performed at standstill. This achieves that the label will not jam and become deformed during the cutting process, since it is supported and held in place by the second roller gap at the discharge end.

This is a significant advantage compared with the prior art, particularly that of WO 2005/023654 A1, because, there, only a suction device that takes up the cut label was disposed at the discharge side of the cutting device consisting of a rotating knife. Such costly suction devices can now be dispensed with according to the invention and an absolutely jam-free position of the cut label is achieved in the roller gap downstream of the cutting means.

With the present invention it is not significant how the tension between the first and second roller gap is created, with the goal of placing the adhesive strip being cut under tension in the region of the cutting device. Various options exist for this, which are claimed as essential to the invention in combination with one another or individually.

According to a first embodiment it is preferred if only the first roller gap on the intake side is driven, and it is again irrelevant whether only one roller of the roller pair of the roller gap is driven or whether both rollers of this roller pair are driven synchronously.

The same also holds true for the second roller pair disposed at the discharge side that serves to provide the second roller gap.

In this context provision may also be made that this second roller pair is driven and that the drive speed of this second roller pair is slightly greater than the drive speed of the first roller pair.

In an additional embodiment of the present invention provision is made that all four rollers of the two roller pairs are driven synchronously by a single drive motor. This creates the advantage of a particularly cost effective drive and the desired tension is now achieved according to the invention in such a way that the diameter of the rollers of the second roller gap is slightly larger than the diameter of the rollers of the first roller gap.

This creates—because of the attained greater circumference speed—a tension onto the adhesive strip being cut without the need for additional drive means or control means. This configuration, accordingly, is particularly simple and safe to operate.

According to a further development of the present invention, provision may also be made that the single drive motor does not drive all four rollers of the two roller pairs synchronously, but only, for example, the respective top roller or the respective bottom roller of the respective roller pair.

The synchronous drive of all four rollers is preferred, however, as this prevents that the glue that runs over one roller of a roller pair in each case leads to unacceptable and undesirable slippage on the adhesive strip.

If—as provided for in the present case—the operation is a start-stop operation, any slip of a non-driven roller in the region of the adhesive layer could result in an undesirable change in the structure of the adhesive layer, thereby later causing a visible and undesirable marking on the adhesive layer of the affixed label.

With the technical teaching of the claimed subject matter of the invention the advantage is created that an automated label applicator for linerless labels can now be attained for the first time with a capacity of up to 240 cutting cycles and label applications per minute. Two double rollers of different diameters tighten the adhesive strip for the cutting process. Preferably all four rollers are driven and the cutting device can cut labels with a width of up to 170 millimeters whereas up to now only labels with a width of 100 mm could be cut. This is due to the fact that labels of such width are held in place jam-free by the second roller gap disposed on the discharge side, permitting also wide labels to be cut, as stated.

By using a linearly moved knife that cuts against a stationary counter knife, the stationary counter knife is exposed and accordingly only a small risk exists that adhesive will accumulate there, thus providing for a long operating time of the cutting device.

The inventive subject matter of the present invention is attained not only from the subject matter of the individual claims but also from the combination of the individual claims with one another.

All of the specifications and characteristics disclosed herein, including in the abstract, and in particular the three-dimensional embodiment shown in the drawings, are claimed as essential to the invention, to the extent that they are novel over the prior art either individually or in combination with one another.

The invention will be explained in more detail below in conjunction with drawings depicting only one possible embodiment. Other essential characteristics and advantages of the invention will become apparent from the drawings and their description, wherein:

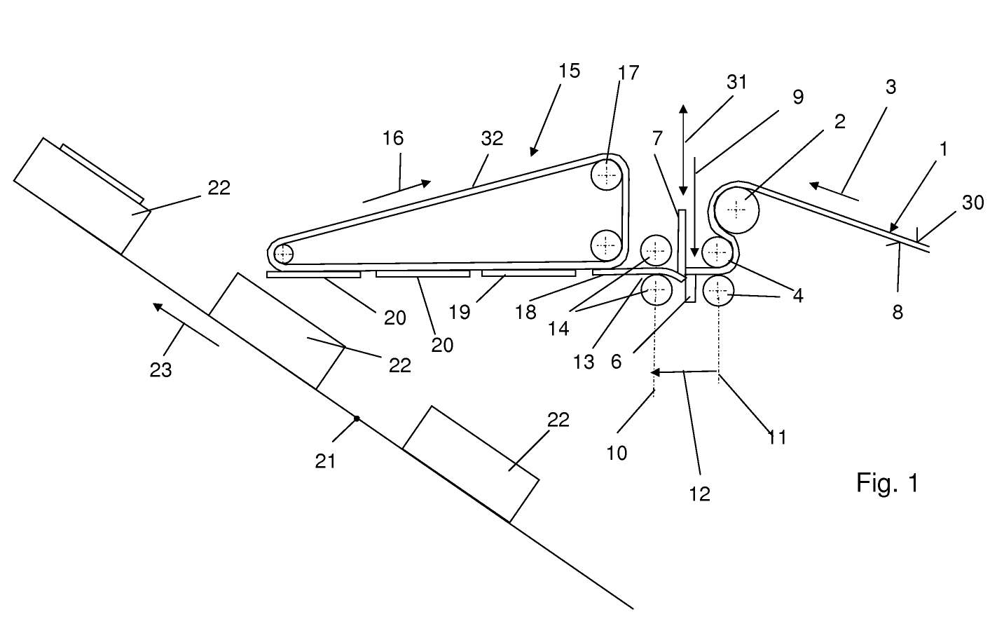

FIG. 1 shows a schematized sectional view of an automated label applicator according to the invention

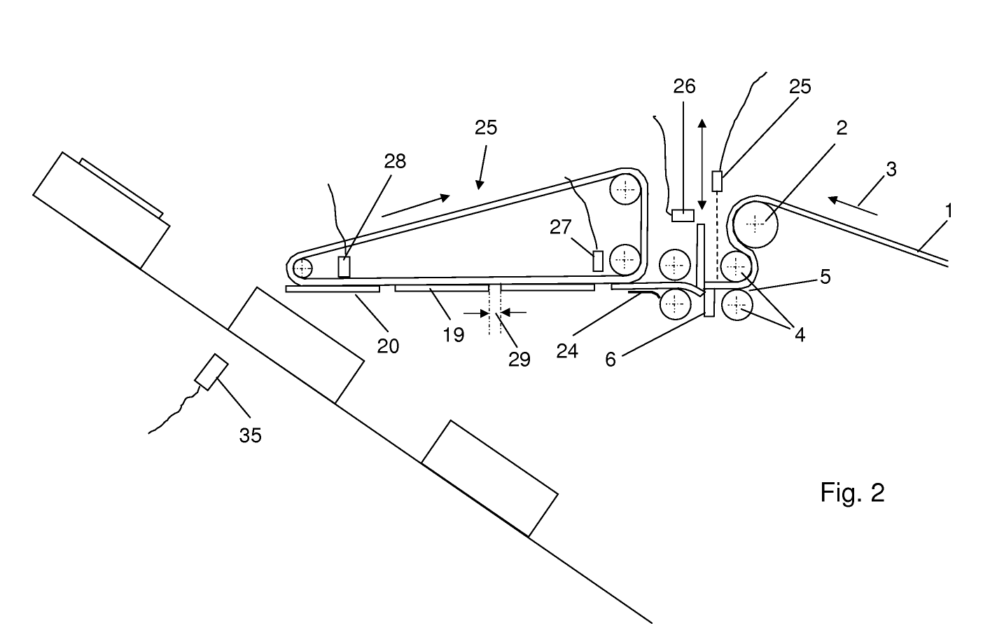

FIG. 2 shows the same illustration as FIG. 1 with additional details entered

In FIGS. 1 and 2 an adhesive strip 1 is shown in a general depiction that is composed of a multi-layer composite consisting in the depicted exemplary embodiment of a film side 30, which may consist of paper or plastic, wherein printing either takes place in the space between the underside of the film side and the glue side 8 or also on the upper side of the film side 30.

This adhesive strip 1 is routed in the direction of the arrow 3 over a first deflection roller 2, whereby good conveyance of the adhesive strip 1 is attained by the large angle of belt wrap.

The deflection roller 2 in this case may be implemented driven or not driven.

Due to the fact that the deflection roller 2 is vertically offset and disposed above the top roller of a first roller pair 4, a very large angle of belt wrap results for the top roller of the first roller pair 4. This considerably reduces any undesirable slip.

The first roller pair 4 thus forms the first roller gap 5, through which the adhesive strip 1 is conveyed.

It is important that downstream of the first roller pair 4 a second roller pair 14 is now disposed, which, in turn, forms a second roller gap 13. Disposed between the first roller pair 4 and the second roller pair 14 in accordance with the invention is now the cutting device, which in the depicted exemplary embodiment consists of a linear cutting device, wherein a cutting knife 7 that is driven so as to be displaceable in the directions of the arrow 31 is moveable linearly and guided in the process against a stationary counter knife 6 that is disposed below the adhesive strip 1.

The invention is not limited in this context to the cutting knife 7 cutting on the paper side 30. Provision may be made in another embodiment that the counter knife and cutting knife are switched against each other, so that the cutting knife 7 cuts on the glue side 8 and the counter knife is disposed opposite from it on the paper side 30.

It is now important that, relative to the axes of the two roller pairs 4, 14 (marked by positions 10 and 11) a tension 12 is created.

According to a preferred embodiment of the invention, provision is made in this context that all rollers of all roller pairs 4, 14 are driven synchronously with a single drive motor, that, however, the diameter of the rollers of the second roller pair 14 is slightly larger than the diameter of the rollers of the first roller pair 4. The diameter difference between the diameter of the rollers of the first roller pair 4 and the rollers of the second roller pair 14 in this context is in the range of 0.1 to 5%.

Disposed at position 9, incidentally, is a sensor that will be explained in more detail in conjunction with FIG. 2.

After the label has been cut off, the cut label 18 is conveyed further, in the direction of the arrow 3 toward a transfer device 15, which, in the presented exemplary embodiment consists of a suction belt 32 that is driven in the direction of the arrow 16 and routed over the deflection rollers 17, 33, 34.

In lieu of a suction belt that operates with a vacuum, other transfer devices may be used as well, in particular a transfer belt operating with electrostatic forces of attraction, and suchlike.

It is important in this context that the drive speed at the deflection rollers 17, 33, 34 (in the direction of the arrow 16) is selected to be slightly greater than the speed with which the cut label 18 leaves the second roller gap 14. This ensures that the cut label 18, while being transferred to the transfer device, is always pulled slightly and never pushed.

This provides for an exact positioning of the label 18 on the suction belt without lateral shifting or jamming.

Via the selection of the take-up speed of the transfer device 15 compared with the discharge speed of the second roller gap 14 it is ensured that the cut labels 18-20 never buckle on the suction belt 32.

In other words, the goal is to always ensure that a spacing 29 exists between the individual successive labels 18-20.

In the region of the leading deflection roller 34 the cut label 20 is now applied onto a product 22, which is fed past in the direction of the arrow 23 on a conveyor belt 21.

Synchronism of the application of the cut label 20 with the product 22 is achieved in this case in the direction of the arrow 23. This will be explained in more detail in conjunction with FIG. 2 and the sensors that are depicted there.

The sensor 35 detects the presence of the product 22 on the conveyor belt 21. It thereby triggers the label application process and the start of the drive of the transfer device 15. The front edge of the leading label 20 in FIG. 2 meets the upper surface of the product 22 when the speed of the transfer device in the direction of the arrow 16 is synchronous with the speed on the conveyor belt 21 in the direction of the arrow 23. The drive of the transfer device 15 stops when the front edge of the subsequent label 19 enters the range of the sensor 28. The control means for the drive for the transfer device 15 has a certain delay time built in.

The sensor 27 provides for jam monitoring, i.e. it serves to monitor the respective spacing 29 between the individual cut labels.

The sensor 25 serves to actuate the cutting device.

The sensor 25 detects a printed mark on the adhesive strip 1 and upon detection of this printed mark the entire drive of the roller pairs 4, 14 is stopped. Immediately after reaching standstill, the cutting process takes place, and the cutting process (movement of the cutting knife 7) is detected by the sensor 26.

The sensor 26 has the function to detect the lowered cutting knife and starts the continued forward feed drive of the roller pairs 4, 14 once the cutting knife 7 has left the adhesive strip 1.

The sensor 25 does not need to detect only a printed mark, but other detection features may be provided on the adhesive strip 1 as well, to which the sensor reacts.

Likewise, it is shown only by way of example that disposed at the discharge point of the second roller pair 14 is a guide track 24 for providing supplementary support of the cut label 18.

Such guide tracks 24 may be disposed also at other points in the transport sequence of the adhesive strip 1. Particularly, such a guide track may also be provided on the intake side in front of the first roller pair.

Moreover, such a guide track may be disposed also between the roller pairs in the region of the cutting device.

According to a further preferred characteristic of the invention, provision is made that also the speed of the transfer device 15 is synchronized with the speed of the conveyor belt 21. If, for example, the speed of the conveyor belt 21 is reduced and thus also the flow of products 22 past the automated label applicator, then the speed of a transfer device 15 is accordingly reduced as well, so as to always achieve a synchronous movement during the application of a label 20 onto the product 22. This prevents that a label will wrinkle while being applied onto the product.

In other respects, in the present invention it is also claimed as essential to the invention to claim—in lieu of a linearly moved mechanical cutting knife 7 with a counter knife 6—other cutting devices as well, namely in particular laser cutting devices or a rotating knife, with the understanding that the rotating knife is disposed in the space between a tension-exerting device consisting of two spaced-apart roller pairs.

### DRAWING LEGEND

1 adhesive strip
2 deflection roller
3 direction of arrow
4 first roller pair
5 roller gap
6 counter knife
7 cutting knife
8 glue side
9 position
10 position
11 position
12 tension
13 roller gap
14 second roller pair
15 transfer device
16 direction of arrow
17 deflection roller
18 cut label
19 cut label
20 cut label
21 conveyor belt
22 product
23 direction of arrow
24 guide track
25 sensor
26 sensor
27 sensor
28 sensor
29 spacing
30 film side
31 direction of arrow
32 suction belt
33 deflection roller
34 deflection roller
35 sensor

What is claimed is:

1. An automated label applicator for linerless labels (18-20) that are cut from a linerless adhesive strip (1) by means of a cutting device having a cutting knife (7), wherein the automated label applicator comprises:
a first roller pair (4) defining between them a roller gap (5) through which the adhesive strip (1) is transported, wherein the cutting knife (7) being disposed downstream of said first roller pair (4); and
a second roller pair (14) with a roller gap (13) is disposed downstream in such a way that the cutting knife (7) is situated in the space between the first and second roller pairs (4, 14), and that a tension onto the adhesive strip (1) being cut is generated in the region of the cutting knife (7) between the first and second roller pairs (4, 14).

2. An automated label applicator according to claim 1, wherein the cutting knife (7) of the cutting device is moved linearly against a counter knife (6).

3. An automated label applicator according to claim 1, wherein the cutting device cuts the label (18) with the adhesive strip (1) being at standstill.

4. An automated label applicator according to claim 1, wherein the cut label (18) is transferred onto a transfer device (15) disposed downstream of the first and second roller pairs (4, 14).

5. An automated label applicator according to claim 4, wherein the take-over speed of the transfer device (15) is slightly greater than the discharge speed of the second roller pair (14) disposed on the discharge side of the cutting knife (7).

6. An automated label applicator according to claim 1, wherein at least one roller of the roller pair (4; 14) on the intake side and/or on the discharge side is driven.

7. An automated label applicator according to claim 1, wherein the drive speed of the second roller pair (14) on the discharge side is slightly greater than that of the first roller pair (4) on the intake side.

8. An automated label applicator according to claim 1, wherein all four rollers of the two roller pairs (4; 14) are driven synchronously by a single drive motor.

9. An automated label applicator according to claim 1, wherein the single drive motor drives only the top roller or bottom roller of the respective roller pair (4; 14).

10. An automated label applicator according to claim 1, wherein the diameter of the rollers of the second roller pair (14) of the discharge side is slightly larger than the diameter of the rollers of the first roller pair (4) on the intake side.
